(19) United States
(12) Patent Application Publication
(10) Pub. No.: US 2023/0171354 A1
(43) Pub. Date: Jun. 1, 2023

(54) IMAGE PROCESSING APPARATUS AND DISPLAY CONTROL METHOD

(71) Applicant: SHARP KABUSHIKI KAISHA, Sakai City (JP)

(72) Inventor: TAKUYA KOUJIRO, Sakai City (JP)

(21) Appl. No.: 17/994,081

(22) Filed: Nov. 25, 2022

(30) Foreign Application Priority Data
Dec. 1, 2021 (JP) 2021-195596

(51) Int. Cl. H04N 1/00

(52) U.S. Cl. CPC H04N 1/0044; H04N 1/0097; H04N 1/00822; H04N 1/00482; H04N 2201/0094

(57) ABSTRACT

According to an embodiment, an image processing apparatus includes: a job executor which executes a job according to a mode; a storage which stores, as history information, a setting history of the job; a display which allows a reception image, which receives an instruction to call the history information that has been stored, to be displayed; and a controller which performs, during execution of the job, display control of the reception image according to the mode.

### BACKGROUND OF THE INVENTION

### Field of the Invention

The present disclosure relates to, for example, an image processing apparatus.

### Description of the Background Art

In some image processing apparatuses such as multifunction peripherals, the apparatus may be one which is related to execution of a job based on each function of copying, faxing, or Email transmission, etc., and store, as history information, setting values related to execution of the job in association with the job.

In recent years, attempts have been made to reduce the user's time and effort concerning execution of a job through the use of stored history information (in the present disclosure, history information associated with setting values will be referred to as a setting history). Specifically, an image processing apparatus displays setting histories on a display in such a way that a setting history can be selected by the user. The image processing apparatus, which has received selection of the setting history by the user, can easily reproduce a job corresponding to the selected setting history by executing the job on the basis of setting values associated with the aforementioned setting history.

Calling of a setting history from a storage can be performed, for example, via an initial screen, which is displayed when the apparatus is started, for example, such as a home screen, or a setting screen for each function selected via the home screen. More specifically, the image processing apparatus displays a reception image, which receives input of an instruction to call a setting history, on the home screen or the setting screen in such a way that the reception image can be selected, and the user selects the reception image. In this way, the setting history can he called.

For example, as indicated in a conventional technology, displaying a history button for calling a job setting history in a history display area of a multifunction peripheral/printer (MFP) is known.

However, the conventional technologies including the above-mentioned conventional technology do not take into account controlling the display/non-display of the reception image depending on execution of the job. For example, after a job has been started (e.g., during document reading), if the reception image is kept displayed at all times, a setting history can be called even after the start of the job. Thus, there is a risk that the setting related to the job may be changed by mistake.

In contrast, if the display of the reception image is kept restricted at all times, it is not possible, for example, to call a setting history via the reception image after the job has been executed (e.g., during preview display). With such a configuration, it is not possible to adapt to a situation where the setting is to be changed in view of a result of checking a preview image.

An object of the present disclosure is to provide an image processing apparatus, for instance, which prevents the setting contents related to execution of a job from being changed by an erroneous operation, and is excellent in operability also for users who may wish to make changes to the setting contents in the process of executing the job.

### SUMMARY OF THE INVENTION

In order to solve the above problem, an image processing apparatus according to the present disclosure is characterized by including: a job executor which executes a job according to a mode; a storage which stores, as history information, a setting value of the job; a display which allows a reception image, which receives an instruction to call the history information that has been stored, to be displayed; and a controller which performs, during execution of the job, display control of the reception image according to the mode.

Also, a display control method according to the present disclosure is characterized by including: a job execution step of executing a job according to a mode; a storage step of storing, as history information, a setting value of the job; a display step of displaying, on a display device, a reception image which receives an instruction to call the history information that has been stored; and a control step of performing, during execution of the job, display control of the reception image according to the mode.

According to the present disclosure, it is possible to provide an image processing apparatus, for instance, which prevents the setting contents set by a user from being changed by an erroneous operation, and is excellent in operability also for users who may wish to make changes to the setting contents in the process of executing a job.

### BRIEF DESCRIPTION OF THE DRAWINGS

FIG. 1 is an external perspective view of a multifunction peripheral according to a first embodiment.

FIG. 2 is a functional configuration diagram of the multifunction peripheral. according to the first embodiment.

FIGS. 3A and 3B are diagrams illustrating a configuration example of a data structure of a setting history.

FIG. 4 is a diagram illustrating a configuration example of a history information display screen.

FIG. 5 is a table illustrating a configuration example of a data structure of job histories.

FIG. 6 is a flowchart illustrating a flow of processing according to the first embodiment.

FIG. 7 is a flowchart illustrating a flow of processing according to the first embodiment.

FIG. 8 is a diagram illustrating an operation example according to the first embodiment.

FIG. 9 is a diagram illustrating an operation example according to the first embodiment.

FIG. 10 is a diagram illustrating an operation example according to the first embodiment.

FIG. 11 is a diagram illustrating an operation example according to the first embodiment.

FIG. 12 is a diagram illustrating an operation example according to the first embodiment.

FIG. 13 is a diagram illustrating an operation example according to the first embodiment.

FIG. 14 is a diagram illustrating an operation example according to the first embodiment.

FIG. 15 is a diagram illustrating an operation example according to the first embodiment.

FIG. 16 is a diagram illustrating an operation example according to the first embodiment.

FIG. 17 is a flowchart illustrating a flow of processing according to a second embodiment.

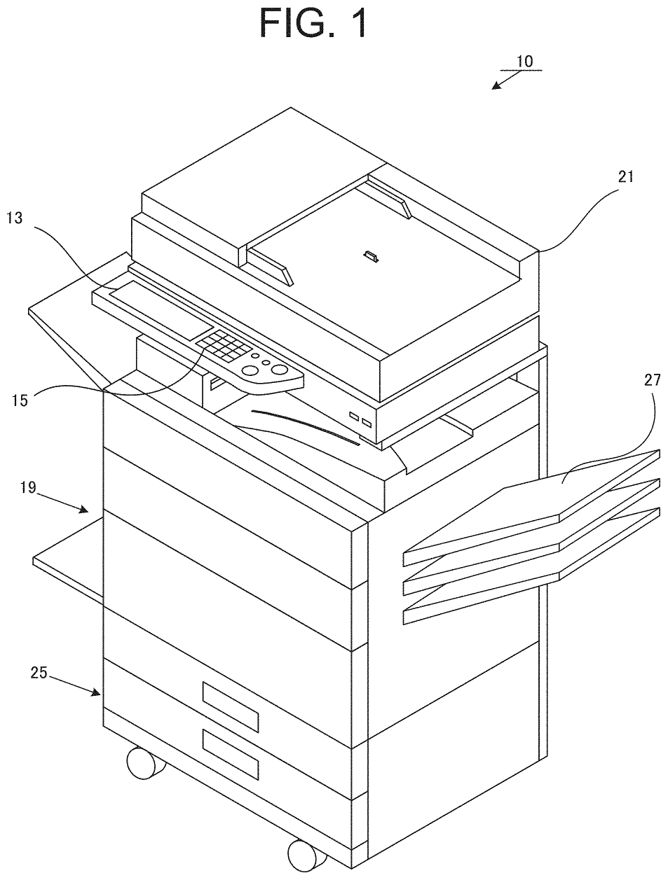

FIG. 1.8 is a diagram illustrating an operation example according to the second embodiment.

FIG. 19 is a diagram illustrating an operation example according to the second embodiment.

FIG. 20 is a diagram illustrating an operation example according to the second embodiment.

FIG. 21 is a flowchart illustrating a flow of processing according to a third embodiment.

FIG. 22 is a diagram illustrating an operation example according to the third embodiment.

FIG. 23 is a diagram illustrating an operation example according to the third embodiment.

### DESCRIPTION OF THE PREFERRED EMBODIMENTS

Embodiments of the present disclosure will be described below with reference to the accompanying drawings. In the present disclosure, a multifunction peripheral that can perform a job based on each function of copying, faxing, image transmission, etc., in a single body will be described as one form of an image processing apparatus. The embodiments described below are presented as examples for explaining the present disclosure, and the technical scope of the embodiments as recited in the appended claims is not limited by the following description.

### 1. First Embodiment

A first embodiment takes the form of performing, during execution of a job, display control of a reception image for calling a setting history according to a mode, and the mode corresponds to a mass document mode as a first mode.

Here, the mode according to the present disclosure refers to a scheme or a method enabling, for example, execution, change, or cancellation of a conclusive output, on the basis of a document read result. More specifically, the mode is, for example, a mass document mode which, in a situation where there exists a large quantity of documents to be read, and an increase in cost by unnecessary output is to be avoided, allows the document read result to be examined carefully, and a decision on a read document (image) to be output by printing or transmission to be made before performing a conclusive output, and a trial print mode which, in a situation where print outputs in large quantity are required and a print output result is to be confirmed in advance, allows an output result of the initial (first page) document to be confirmed before performing a conclusive output. The multifunction peripheral described in the present disclosure is an image processing apparatus capable of executing a job according to the mode described above.

### 1.1 Functional Configuration

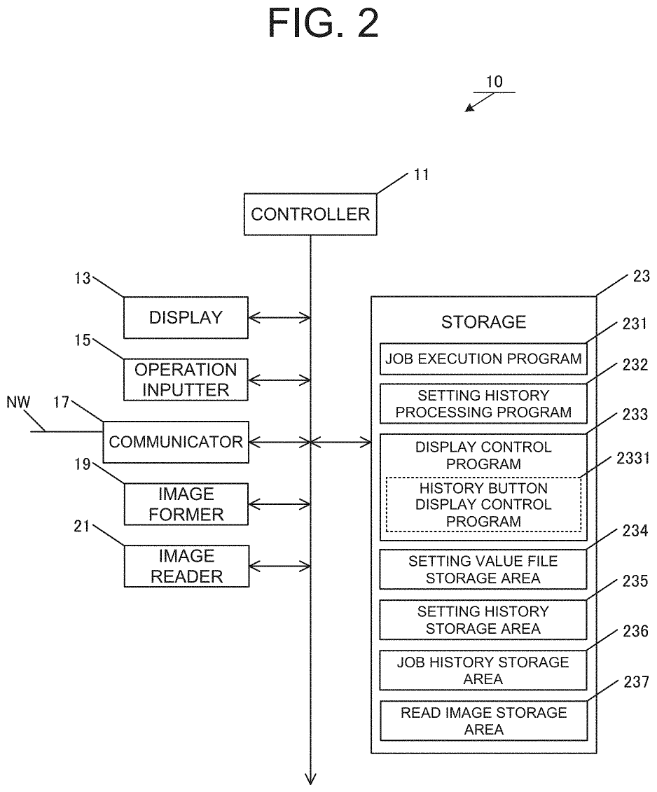

A functional configuration of a multifunction peripheral 10 according to the first embodiment will he described with reference to FIGS. 1 and 2. FIG. 1 is an external perspective view which schematically illustrates an overall configuration of the multifunction peripheral 10. FIG. 2 is a functional configuration diagram of the multifunction peripheral 10. The multifunction peripheral 10 is provided with a controller 11, a display 13, an operation inputter 15, a communicator 17, an image former 19, an image reader 21, and a storage 23.

The controller 11 performs overall control of the multifunction peripheral 10. The controller 11 is configured from, for example, one or more arithmetic devices (e.g., central processing units [CPUs]). The controller 11 reads and executes various programs stored in the storage 23, thereby implementing functions thereof.

The display 13 displays various kinds of information to a user, for example. The display 13 can be composed of, for example, a liquid crystal display (LCD) or an organic electro-luminescence (EL) display.

The operation inputter 15 receives input of information by the user, for example. The operation inputter 15 can be configured from, for example, a hard key (e.g., a numeric keypad), buttons, and the like. The operation inputter 15 can be configured as a touch panel that allows input via the display 13. In this case, for example, a common method such as a resistive method, an infrared method, an electromagnetic induction method, or a capacitive sensing method may be employed as an input method for the touch panel.

The communicator 17 is provided with either of or both of wired and wireless interfaces to communicate with another device via a network (NW) such as a local area network (LAN), a wide area network (WAN), the Internet, a telephone line, or a fax line.

The image former 19 forms, on a sheet of paper as a recording medium, an image based on image data. The image former 19 feeds paper from a paper feeder 25, forms an image based on the image data on the paper, and thereafter discharges the paper to a paper discharger 27. The image former 19 can be composed of, for example, a laser printer using an electrophotographic method. In this case, the image former 19 forms an image by using toners supplied from toner cartridges, which are not illustrated, corresponding to respective toner colors (e.g., cyan, magenta, yellow, and black).

The image reader 21 scans and reads a document, thereby generating image data. The image reader 21 as a reading unit can be configured, for example, as a scanner device provided with an image sensor, such as a charge-coupled device (CCD), a contact image sensor (CIS), or the like, and including an automatic document feeder (ADF). As long as the image reader 21 is configured to generate the image data by reading a reflected light image from a document image by using the image sensor, the configuration thereof is not limited. In the present disclosure, processing of reading all of the documents (which may be one or more than one in number) set to the image reader 21 is referred to as document reading. Therefore, in the present disclosure, reading processing of reading the documents through multiple divided reads is also referred to as document reading.

The storage 23 stores therein various kinds of data and various programs necessary for operation of the multifunction peripheral 10. The storage 23 can be configured from, for example, storage devices such as a random-access memory (RAM), a hard disk drive (HDD), a solid state drive (SSD), and a read-only memory (ROM).

In the first embodiment, the storage 23 stores therein a job execution program 231, a setting history processing program 232, and a display control program 233. Further, in the storage 23, a setting value file storage area 234, a setting history storage area 235, a job history storage area 236, and a read image storage area 237 are reserved.

The job execution program 231 is a program that the controller 11 reads in order to perform processing associated with execution of each function of copying, faxing, image data transmission, etc., on a job-by-job basis. The controller 11 that has read the job execution program 231 executes a job by controlling the display 13, the operation inputter 15, the communicator 17, the image former 19, the image reader 21, and the like, which serve as job executors. Further, the controller 11 that has read the job execution program 231 can execute various jobs on the basis of setting values included in setting value files of the respective setting histories.

The setting history processing program 232 is a program that the controller 11 reads when, for example, acquisition of a setting value related to execution of a job, generation of a setting history, and various kinds of processing with respect to the setting history are to be performed. The controller 11 that has read the setting history processing program 232 acquires setting values related to the execution of the job, and generates a setting value file containing the setting values. Then, the controller 11 stores the generated setting value file in the setting value file storage area 234. In addition, the controller 11 generates a setting history as history information by associating the setting value file with identification information (e.g., history ID) used for identifying to which job the setting history is related. Further, the controller 11 stores the generated setting history in the setting history storage area 235.

The display control program 233 is a program that the controller 11 reads when displaying, on the display 13, a display screen that displays the setting histories as a list; a setting screen that receives input of various setting values related to execution of a job, an execution instruction, or an end instruction, for example; an initial screen (e.g., a home screen) that displays the setting screens in a switchable manner; or a login screen for user authentication, for example. In addition, the controller 11 that has read the display control program 233 performs display control of a history button, which serves as a reception image that receives an instruction to call the setting histories stored in the setting history storage area 235.

Also, the display control program 233 includes a history button display control program 2331. As the controller 11 reads the history button display control program 2331, display control of the history button to be described later is performed.

The setting value file storage area 234 is a storage area for storing the setting value file generated by the controller 11 that has read the setting history processing program 232. The setting values include, for example, setting values of a color mode, a resolution, a format, a density, and the like, set by the user, and setting values such as a device default value held by the device itself. The controller 11 that has read the job execution program 231 can acquire the setting value file associated with the setting history, which is to he used for execution, from the setting value file storage area 234, and execute a job on the basis of the setting values included in the acquired setting value file.

The setting history storage area 235 is a storage area for storing the setting history generated by the controller 11 that has read the setting history processing program 232. The setting histories stored in the setting history storage area 235 are read as appropriate during display processing or when a job based on the relevant setting history is to be executed, for example.

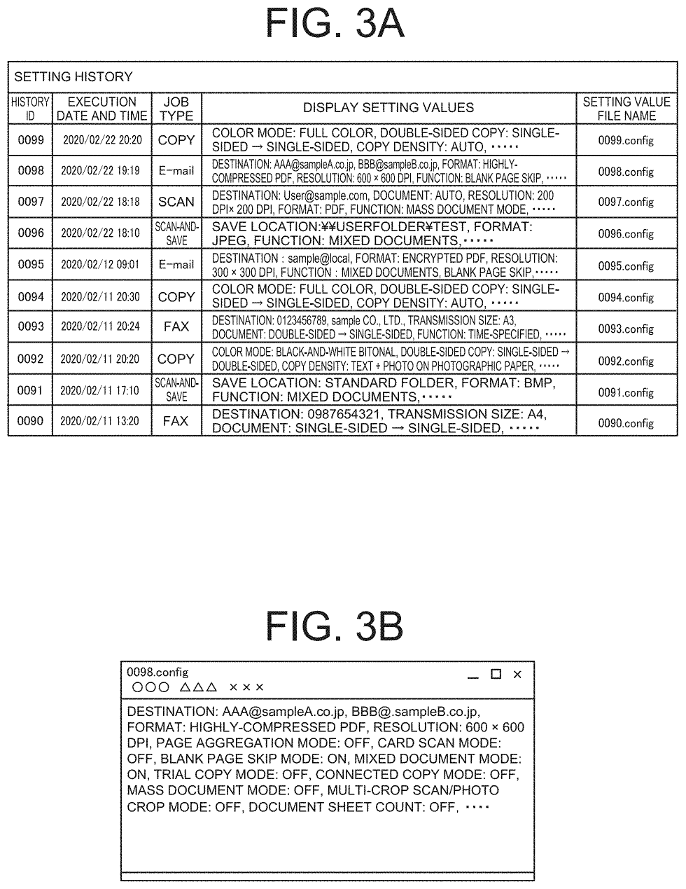

The setting history related to the present disclosure will now be described. FIG. 3A is a table illustrating a configuration example of a data structure of the setting histories stored in the setting history storage area 235. FIG. 3B is a diagram illustrating a configuration example of a data. structure of a setting value file associated with the setting history of FIG. 3A.

The setting histories exemplified in FIG. 3A include the history ID, execution date and time, job type, display setting values, and setting value file name.

The history ID is identification information for uniquely identifying the setting history. The history ID is assigned to each setting history generated. As exemplified in FIG. 3A, the history ID may be a serial number, or may include a predetermined character string, symbols, or the like. The execution date and time indicates the date and time of the execution of each job. The job type indicates the type of a job executed (e.g., a copy job, a fax job, an E-mail transmission job, etc.). The display setting values indicate a part of the setting values (contents) to be displayed on the display screen that displays the setting histories as a list. The setting value file name represents the file name of the setting value file associated with the relevant setting history.

For example, the setting history pertaining to history ID “0099” indicates a setting history related to “Copy”, as the job type, executed at 20:20 on Feb. 22, 2020. The job is a copy job executed on the basis of setting values included in a file with the setting value file name “0099. config”, and represents an example in which the setting values (items) such as “Color mode: Full color, Double-sided copy: Single-sided→Single-sided, Copy density: Auto, . . . ” are set as the display setting values. Note that the display setting values set for each history ID are merely examples, and the setting values displayed on the display screen are not limited to those illustrated in FIG. 3A.

FIG. 3B shows an example of a data structure of a setting value file named. “0098.config” that is associated with history if) “0098.” The setting value file exemplified in FIG. 3B can be configured as a text file or binary data storing, for example, setting values related to execution of a job, such as “Destination: AAA@sampleA.co.jp, BBB@.sampleB.co.jp, Format: Highly-compressed PDF, Resolution: 600×600 dpi, Page aggregation mode: off, Card scan mode: off, Blank page skip mode: on, Mixed document mode: on, Trial copy mode: off, Connected copy mode: off, Mass document mode: off, Multi-crop scan/Photo crop mode: off, Document sheet count: off, . . . ”. In executing a job based on a setting history, the controller 11 executes the job related to the setting history by using the setting values stored in the relevant setting value file. Further, when processing related to the job is finished, the controller 11 stores the setting values that have been used for the job execution in a setting value file. The “*** mode” exemplified in FIG. 3B is an example of the modes applicable to the present disclosure.

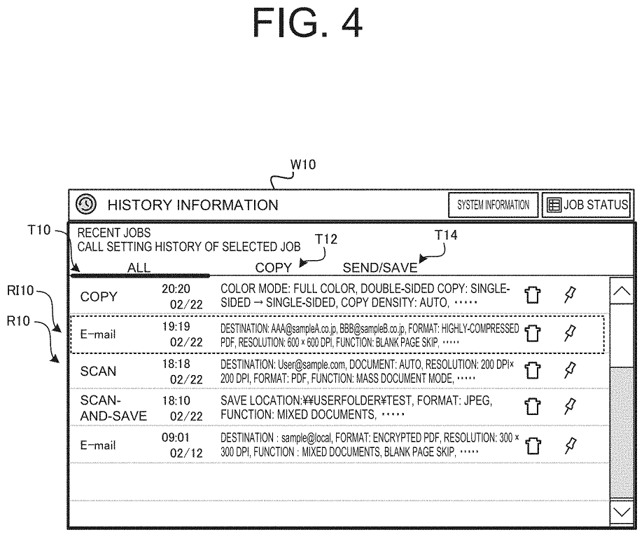

FIG. 4 shows a configuration example of a history information display screen W10 that the controller 11 displays on the display 13 in response to the user's selection of a history button.

The history information display screen W10 includes a history information display area R10. The history information display area R10 is a display area in which the controller 11 calls and displays, in response to the user's selection of the history button, the setting histories stored in the setting history storage area 235. The history information display area R10 displays the job type, the job execution date and time, and the display setting values, as the setting history of each job. For example, the setting history displayed at the top row in the display area is a display example of a setting history (corresponding to the setting history of history ID “0099” exemplified in FIG. 3A) related to a copy job executed at 20:20 on February 22.

In the example illustrated in FIG. 4, only the setting histories of history ID “0099” to history ID “0095” exemplified in FIG. 3A are displayed. However, by operating a scroll bar provided on the right side of the display area, the setting history of history ID “0094” and those subsequent to history ID “0094” can be displayed.

Incidentally, an “All” tab T10, a “Copy” tab T12, and a “Send/Save” tab T14, which are provided in the history information display area R10, are selection tabs for displaying, after performing filter processing of the setting histories on the basis of the job type, the setting histories in the display area. FIG. 4 illustrates an example in which the “All” tab T10 is selected, in other words, the example in which the setting histories are displayed in the order of job execution date and time (i.e., descending order) regardless of the job type. Here, for example, when the “Copy” tab T12 is selected by the user, the controller 11 performs filter processing of the setting histories stored in the setting history storage area 235 by using the search value “Copy”. The controller 11 displays, on the basis of a result of the filter processing, the setting histories whose job type is copy in the order of job execution date and time (i.e., descending order).

Each of the setting histories displayed in the history information display area R10 is configured to be selected by the user. For example, when the setting history related to copy of history ID “0099” is selected by the user, the controller 11 calls the setting value file associated with history ID “0099” (i.e., the setting value file “0099.config” of FIG. 3A), and displays a setting screen to which each of the setting values stored in the called setting value file is applied. The user can execute a job based on the relevant setting history by inputting an instruction to execute the job via the displayed setting screen.

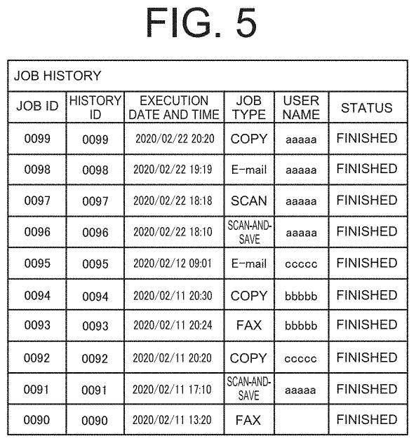

Returning to FIG. 2, the job history storage area 236 is a storage area for storing a job execution record as a job history. The job history related to the present disclosure will now be described. FIG. 5 is a table illustrating a configuration example of a data structure of the job histories stored in the job history storage area 236.

The job histories related to the example illustrated in FIG. 5 include the job ID, history ID, execution date and time, job type, user name, and status.

The job ID is an identifier to uniquely identify the job that has been executed. The job ID is generated each time the job is executed. The job ID may be a serial number, as exemplified in FIG. 5, or may include a predetermined character string, symbols, or the like.

The history ID, the execution date and time, and the job type are the same items as those included in the setting history illustrated in FIG. 3, and have the same contents as those of FIG. 3. The user name indicates the name of a user who has executed the job. The status indicates the processing status of the job. In the example illustrated in FIG. 5, although the job ID and the history ID indicate identical values, they do not need to be identical values. That is, as long as the job history and the setting history can be associated with each other in terms of management, the value to be assigned is not particularly limited.

For example, the job history pertaining to job ID “0097” indicates a job history related to “Scan”, as the job type, executed at 18:18 on Feb. 22, 2020. Further, the job indicates that an execution instruction has been input by a user having the user name “aaaaa”, and the status of the job is “finished”.

Unlike the setting history, the job history is information in which a job execution history is recorded, and the timing of generating the job history is not particularly limited. For example, the job history can be generated at an arbitrary timing, such as the timing of before or after the job is executed, or before or after the setting history is generated.

The read image storage area 237 is a storage area for storing image data generated on the basis of a document image read by the image reader 21.

### 1.2. Flow of Processing

### 1.2.1. Regarding Overall Processing

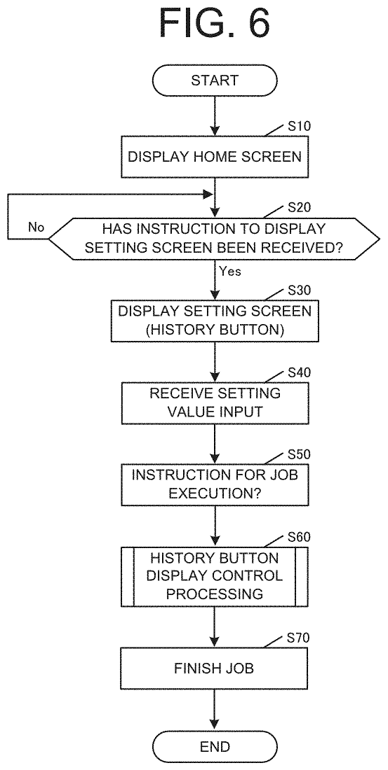

Next, a flow of processing of the first embodiment will be described. First, a flow of overall processing executed by the multifunction peripheral 10 will be described with reference to a flowchart of FIG. 6. The controller 11 reads the job execution program 231, the setting history processing program 232, the display control program 233, and the like, as appropriate, thereby executing each processing step described referring to FIG. 6.

First, when an apparatus is started, such as when the apparatus is powered on or a sleep mode is cancelled, if a user authentication function is enabled, the controller 11 displays a home screen as the initial screen on the display 13 after, for example, the user has been successfully authenticated (step S10).

The controller 11 determines whether or not an instruction to display a setting screen of a job desired by the user (hereinafter simply referred to as the setting screen) is received (step S20). The controller 11 distinguishes between the setting screens related to each job type, on the basis of an instruction of selecting the setting screen that has been received via the home screen. By doing so, the controller 11 can determine whether or not input of an instruction to display a setting screen desired by the user is received.

If it is determined that an instruction to display a setting screen is received, the controller 11 displays the setting screen together with the history button on the display 13 (step S20; Yes→step S30). Meanwhile, if it is determined that no instruction to display a setting screen is received, the controller 11 waits until such a display instruction is received (step S20; No).

The controller 11 receives input of a setting value by the user via the displayed setting screen (step S40). Further, when the controller 11 receives an instruction to execute a job from the user, the controller 11 executes the job. The controller 11 executes history button display control processing at the same time as starting the job or after starting the job (step S50→step S60).

When the job started in step S50 is finished (step S70), the controller 11 ends the processing. Here, in determining an end of a job, the time when processing to be executed by the controller 11 on the basis of the job execution program 231 is finished (in other words, the time when the job execution program 231 is released from a working memory) may be determined as an end of the job, or the point of time when an output result of the job (e.g., output as a printed material or transmission as image data) is actually obtained may be determined as an end of the job.

### 1.2.2 Regarding History Button Display Control Processing in Mass Document Mode

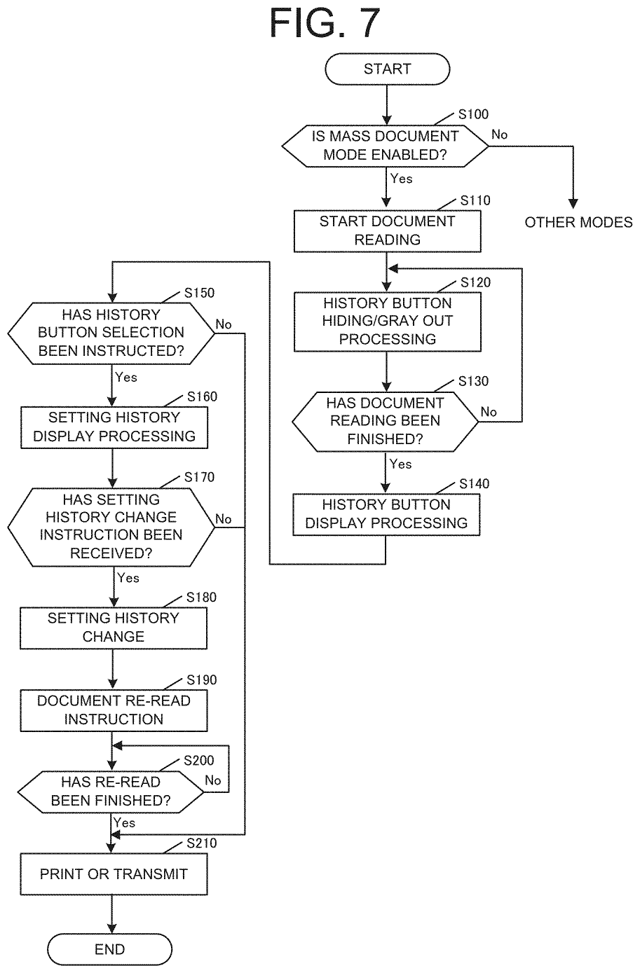

Next, history button display control processing in step S60 of FIG. 6 will be described with reference to a flowchart of FIG. 7. In FIG. 7, a mass document mode as the first mode is described. The processing described with the flowchart of FIG. 7 is processing executed by the controller 11 as the controller 11 mainly reads the history button display control program 2331.

In step S50 of FIG. 6, when an instruction to execute a job is received, the controller 11 determines whether or not a mass document mode is enabled (step S100). The controller 11 can determine that the mass document mode is enabled when, for example, a mass document mode button displayed on the setting screen is directly selected ley the user, or when the setting value of the mass document mode stored in the setting value file is set to “On (enabled)”.

If it is determined that the mass document mode is made enabled, the controller 11 starts document reading by controlling the image reader 21 (step S100; Yes→step S110). Meanwhile, if it is determined that the mass document mode is made disabled, the controller 11 determines that a mode other than the mass document mode is set (step S100; No “Other modes”).

When the document reading is started, the controller 11 performs display control to hide or gray out the history button (step S120). By restricting the display of the history button when the image reader 21 is reading a document, it is possible to prevent the user from operating (selecting) the history button by mistake.

Then, the controller 11 determines whether or not the document reading by the image reader 21 has been finished (step S130). Here, as the controller 11 receives a read end signal which is output from the image reader 21, the controller 11 can determine that the document reading has been finished. Also, the controller 11 may determine that; the timing when a document; detection signal from a document detection sensor (which is mechanical or optical) provided in the ADF is no longer detected, for example, corresponds to an end of the document reading.

If it is determined that the document reading by the image reader 21. has been finished, the controller 11 performs display processing for the history button (step S130; Yes→step S140). Meanwhile, if the controller 11 determines that the document reading by the image reader 21 has not been finished, the controller 11 continues the display control to hide or gray out the history button (step S130; No→step S120).

After performing the display processing for the history button, the controller 11 determines whether or not an instruction of selecting the history button by the user is received (step S150). If it is determined that an instruction of selecting the history button by the user is received, the controller 11 performs display processing of displaying the setting histories (step S150; Yes→step S160). If it is determined that no instruction of selecting the history button by the user is received, the controller 11 shifts the processing to step S210 (step S150; No→step S210).

Then, the controller 11 determines whether or not a setting history has been selected from among the displayed setting histories, and an instruction for change to the selected setting history is received (step S170).

If an instruction for setting history change is received, the controller 11 performs a change to the selected setting history (step S170; Yes→step S180). If it is determined that no instruction for setting history change is received, the controller 11 shifts the processing to step S210 (step S170; No→step S210).

When the controller 11 receives a document reread instruction after performing the setting history change, the controller 11 controls the image reader 21 to (re-)read the document on the basis of the changed setting history (step S190). Then, the controller 11 determines whether or not re-reading of the document by the image reader 21 has been finished (step S200).

If it is determined that re-reading of the document has been finished, the controller 11 executes printing or transmission processing, on the basis of the document read result, and ends the processing (step S200; Yes→step S210).

Note that in step S170 and step S180 of FIG. 7, although the processing of performing a change to the setting history selected by the user has been described, it is of course possible to further change the setting values of the selected setting history. In this case, the controller 11 executes document read processing on the basis of the changed setting values.

### 1.3 Operation Examples

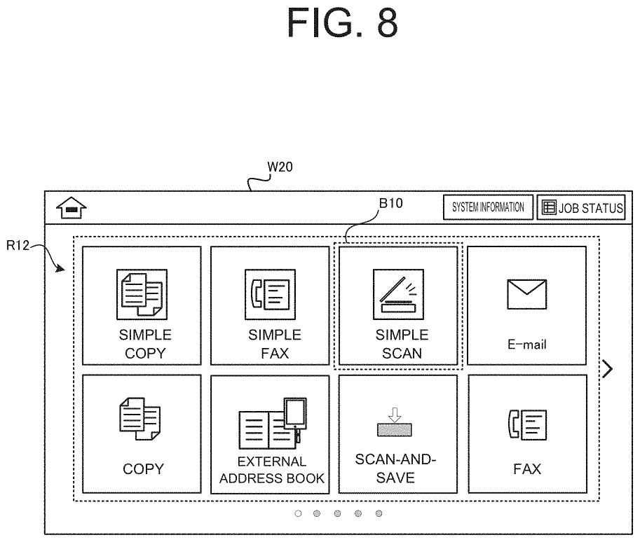

Next, an operation example according to the first embodiment will be described. FIG. 8 is a diagram illustrating a configuration example of a home screen W20 that the controller 11 displays on the display 13, FIG. 8 illustrates an operation example corresponding to processing of step S10 of FIG. 6.

The home screen W20 includes a function selection area R12.

The function selection area R12 is an area which displays, in a consolidated manner, selection buttons for receiving an instruction of selection of each function (setting screen) related to execution of a job, or selection such as reference to an external address book. The selection buttons are selection buttons having a screen configuration in which each of the functions and the like is illustrated by figures, characters/numbers, or symbols, etc. In response to selection (pressing) of a selection button by the user, the controller 11 displays a setting screen or an information display screen for a function corresponding to the selection button.

The function selection area R12 shown in FIG. 8 is an example in which the function selection area is configured from selection buttons for receiving selection of one of Simple Copy, Simple Fax, Simple Scan, E-mail, Copy, Scan-and-Save, and Fax, and a selection button for receiving selection of reference to an external address book. Here, “Simple” in “Simple Copy”, etc., is intended as the function in which the setting values (setting items) that can be selected in normal copy are made impossible to be set on purpose (or made fixed default settings), so that an operation related to execution of the job is simplified. For example, the user can easily execute a job related to copy without making any complicated settings by selecting Simple Copy as the job. Since the setting values (setting items) that can be set on the setting screen differ between a simple function of “Simple Copy”, etc., and a normal function of “Copy” etc., screen configurations thereof are also different. In the present disclosure, an embodiment in which display control of the history button is enabled for both of the two functions of the simple function and the normal function will be described.

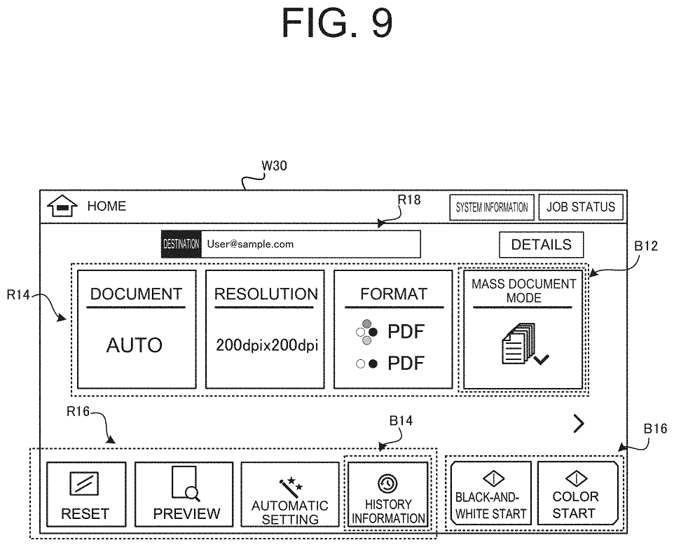

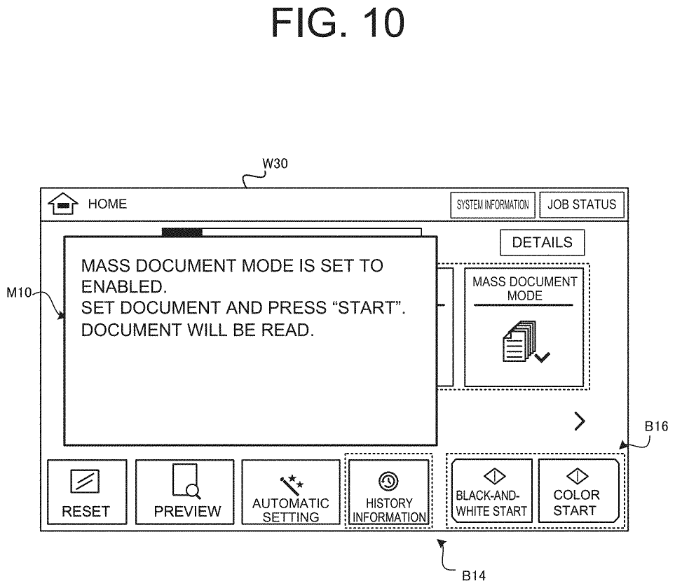

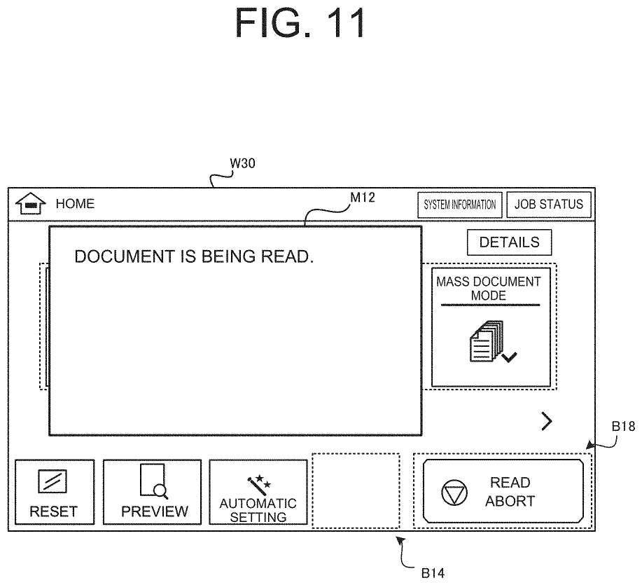

FIG. 9 is a diagram illustrating a configuration example of a setting screen W30 related to “Simple Scan” displayed by the controller 11, in response to input of an instruction of selecting a simple scan button B10 that is included in the function selection area R12 shown in FIG. 8. FIG. 9 illustrates an operation example corresponding to processing of step S30 of FIG. 6.

The setting screen W30 includes a setting value display area R14, a control button display area R16, start buttons B16, and a destination display area R18.

The setting value display area R14 receives selection/input of a setting value that can be set by the user via the setting screen W30. As the setting values (items) that can be set, FIG. 9 shows an example in which four types of setting values (items), which are Document (Auto), Resolution (200 dpi×200 dpi), Format (PDF), and Mass Document Mode, are displayed. The setting values (items) exemplified in the setting value display area R14 of FIG. 9 correspond to the setting history of history ID “0097” exemplified in FIG. 3.

In the setting values of history ID “0097”, when the mass document mode as the first mode is set to enabled, the setting value display area R14 displays a mass document mode button B12, as exemplified in FIG. 9. The mass document mode button B12 receives input for switching between enabled and disabled of the mass document mode. In the case of the example illustrated in FIG. 9, it is indicated that the mass document mode is enabled, and the mass document mode can be executed as a job. If the mass document mode is to be disabled, the user can select the mass document mode button B12 to switch between enabled and disabled, thereby setting the mass document anode to disabled.

The control button display area R16 includes, for example, a reset button, a preview button, an automatic setting button, a history information button B14 as the history button, and the like. For example, the reset button is a button which receives an instruction to reset the setting values selected/input via the setting value display area R14, etc. The preview button is a button which receives, for example, an instruction to display a preview image to be described later. The automatic setting button is a button which receives application of device settings and the like configured in the system settings. The history information button B14 is a button which receives an instruction to call the setting histories. When the history information button B14 is selected by the user, the controller 11 displays the history information display screen W10 exemplified in FIG. 4.

The start buttons B16 include a black-and-white start button and a color start button. If the user wishes to send a black-and-white image, he/she selects the black-and-white start button. Meanwhile, if the user wishes to send a color image, he/she selects the color start button. When one of the black-and-white start button and the color start button is selected by the user, the controller 11 executes a scan-and-send transmission to a destination displayed in the destination display area R18.

The destination display area R18 is a display area for displaying a destination of the scan-and-send transmission. FIG. 9 shows an example in which the transmission destination “User@sample.com” based on the setting history of history ID “0097” exemplified in FIG. 3 is displayed.

When an input instruction for the start button B16 is received on the setting screen W30 shown in FIG. 9, the controller 11 performs display control for the history information button B14.

FIG. 10 is a diagram illustrating a configuration example of a message image M10 displayed by the controller 11 when the mass document mode is set to enabled.

The message image M10 displays a message saying, for example, “Mass document mode is set to enabled. Set document and press ‘Start’. Document will be read.”. By such a display, the user is informed of a start of document reading in the mass document mode.

As the user confirms the message contents displayed in the message image M10 and selects the start button B16, the document reading in the mass document mode can be started.

FIG. 11 is a diagram illustrating one form of the display control of the history information button B14 to be executed by the controller 11, in response to input of an instruction of selecting the start button B16 on the setting screen W30.

When the controller 11 receives an instruction to execute a job in the mass document mode, the controller 11 performs control to hide the history information button B14 for calling the setting histories in this case, the controller 11 can display a message image M12 displaying a message “Document is being read.” to be superimposed on the setting screen W30, so that the user can be aware that the document is being read, or can change the button display from the start button B16 to a read abort button B18 which receives an instruction to abort the reading.

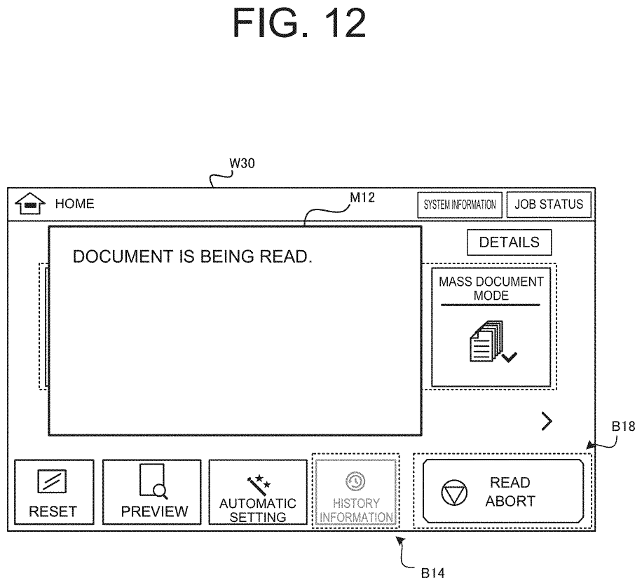

FIG. 12 is a diagram illustrating display control to perform gray-out display for the history information button B14 by the controller 11. As in the example illustrated in FIG. 11, during the document reading, the controller 11 performs display control in such a way as to display the history information button B14 to be grayed out, and not to allow selection thereof by the user.

Generally, the size of a document to read is determined automatically or manually during the document reading. Therefore, if the configuration is one that allows setting histories to be called even at the timing of the document reading, the setting values related to the document size may he overwritten, and an incorrect action unintended by the user may occur. As in the examples illustrated in FIGS. 11 and 12, during the document reading, the display of the history information button B14 for calling the setting histories is restricted. Thereby, it is possible to prevent occurrence of an incorrect action due to an erroneous operation by the user or overwriting of the setting values.

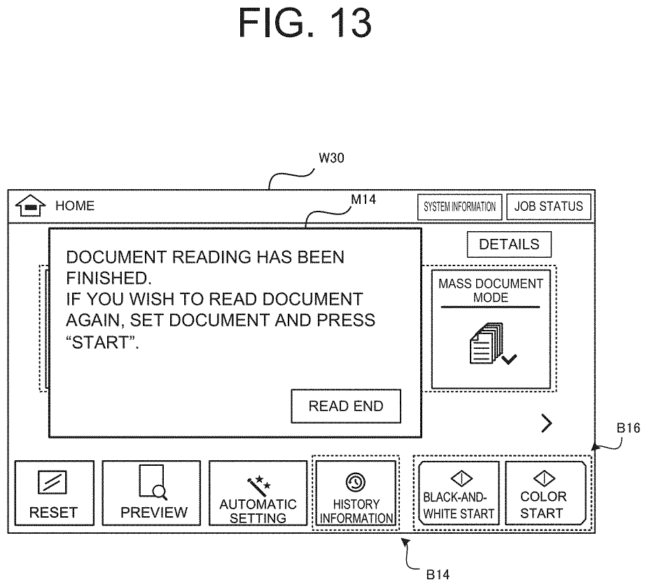

When the document reading is finished, the controller 11 performs display control to display the history information button B14. FIG. 13 is a diagram illustrating one form of display control executed by the controller 11 when the document reading is finished.

As exemplified in FIG. 13, when the document reading is finished, the controller 11 removes the restriction on display for the history information button B14. In this case, a message screen M14 which displays a message indicating that the document reading has been finished, such as “Document reading has been finished. If you wish to read document again, set document and press ‘Start’.”, may also be displayed.

Also, at this time, the controller 11 displays the history information button B14 in such a way that the history information button B14 is allowed to be selected. As can be seen, at the point of time when the document reacting is finished, the history information button B14 is displayed in such a way that the history information button B14 is allowed to be selected. Thus, the document reading can be performed again by first making changes to the setting history before executing a conclusive transmission or print instruction (in a case where the function is Simple Copy or Copy).

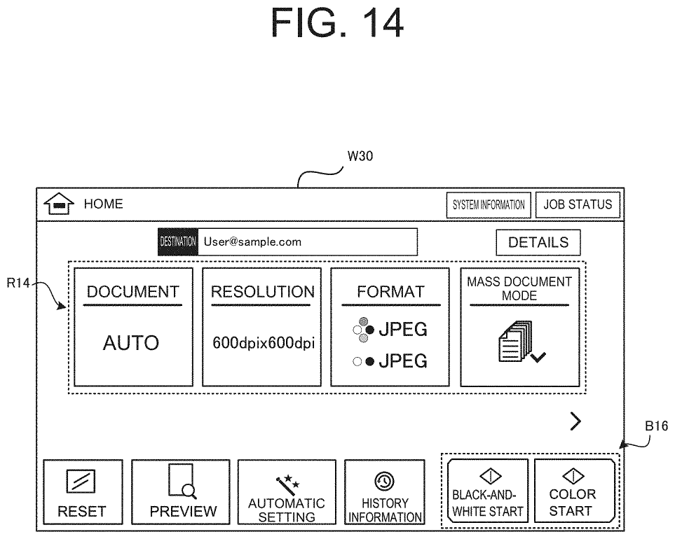

FIG. 14 is a diagram illustrating a configuration example of the setting screen W30 displayed by the controller 11 when the history information button B14 is selected by the user, and the setting history is changed from the setting history exemplified in the setting screen W30 of FIG. 9 to another setting history.

FIG. 14 shows a display example of the setting screen W30 when the setting history is changed from the setting history (the setting value display area R14) exemplified in FIG. 9 to a setting history having a different resolution (200 dpi×200 dpi→600 dpi×600 dpi) and format (PDF→JPEG). After performing the setting history change, as the user selects the start button B16, he/she can perform image reading on the basis of the setting history different from the example illustrated in FIG. 9.

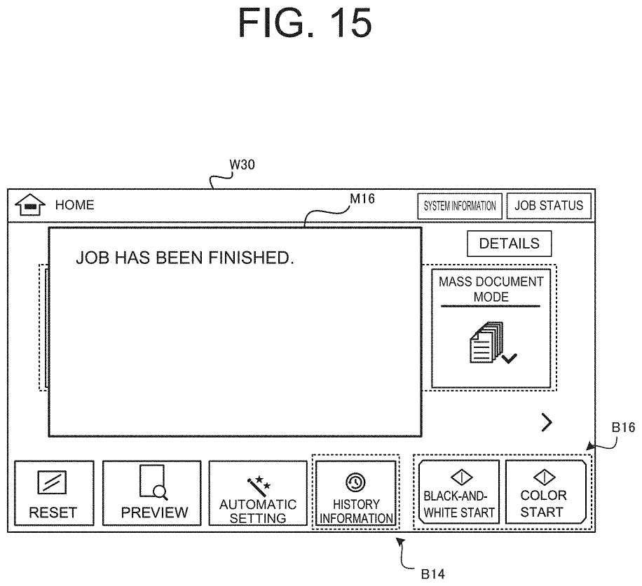

FIG. 15 shows a configuration example of a message image M16 which displays that the job has been finished, when a conclusive transmission or print instruction (in a case where the function is Simple Copy or Copy) has been executed after the document reading. In the message image M16, by displaying a message, such as “Job has been finished.”, indicating that a job related to the mass document mode has been finished, the user can understand that the job has been finished.

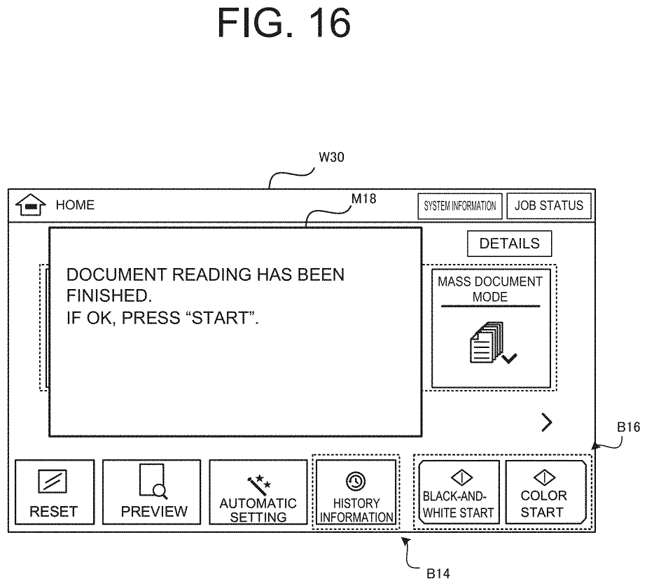

In the first embodiment, the mass document mode has been described as the first mode of reading a plurality of documents from the image reader. The first embodiment can be applied not only to the mass document mode, but also to a trial printing mode or the like as a second mode which requires the user's judgment on the read result from the image reader. When the second mode is to be applied, for example, in performing the processing of step S140 of FIG. 7, judgment by the user may be sought by, as exemplified in FIG. 16, displaying an inquiry image M18, which inquires about whether the user intends to give a conclusive instruction using the document read result, together with the display processing for the history button.

As described above, according to the first embodiment, during the document reading processing, the display of the history information button for calling the setting histories is restricted. Thereby, it is possible to prevent occurrence of an incorrect action due to an erroneous operation by the user or overwriting of the setting values. In addition, since the setting history can be changed in the process of executing a job, it is possible to provide an image processing apparatus which is excellent in operability also for users who wish to change the setting contents.

### 2. Second Embodiment

A second embodiment takes the form of performing, when a job is that which uses a setting history as history information, display control of a history button as a reception image, regardless of the mode in action.

### 2.1 Functional Configuration

Since the functional configuration of a multifunction peripheral according to the second embodiment can be made substantially the same as that of the multifunction peripheral 10 according to the first embodiment, the same functions are represented by the same reference numerals, and description thereof is omitted here.

### 2.2 Flow of Processing

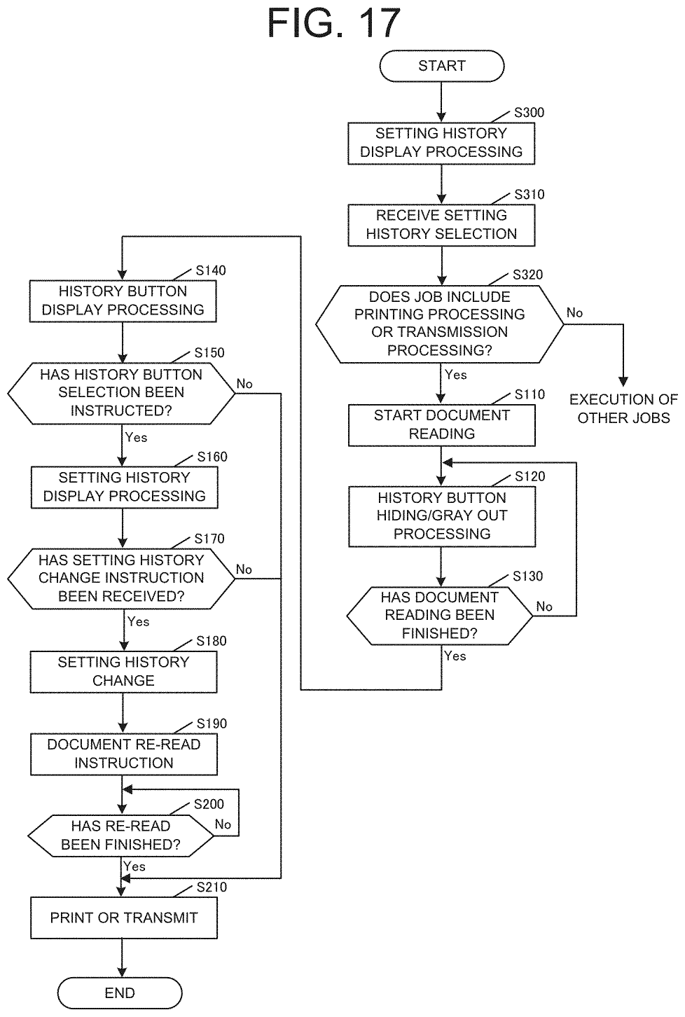

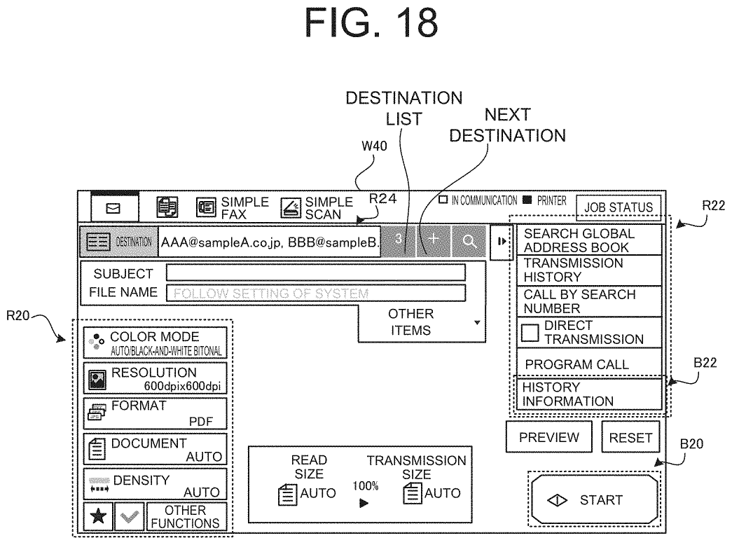

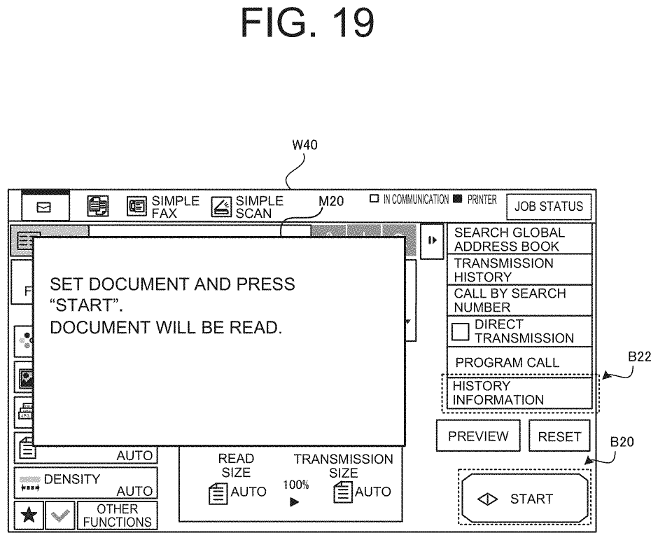

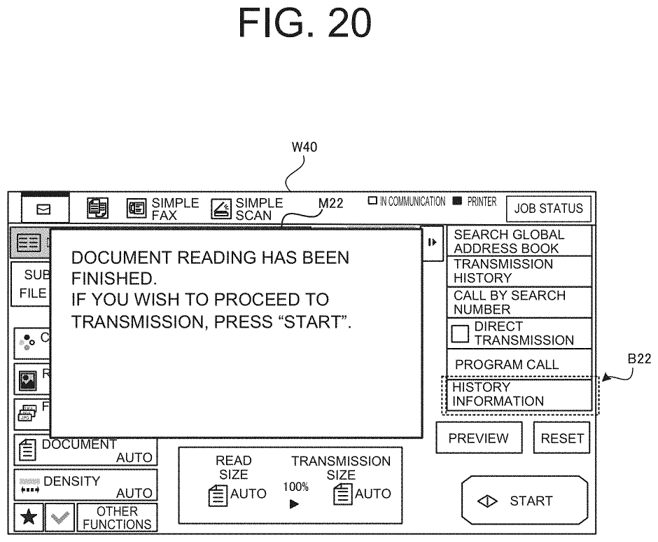

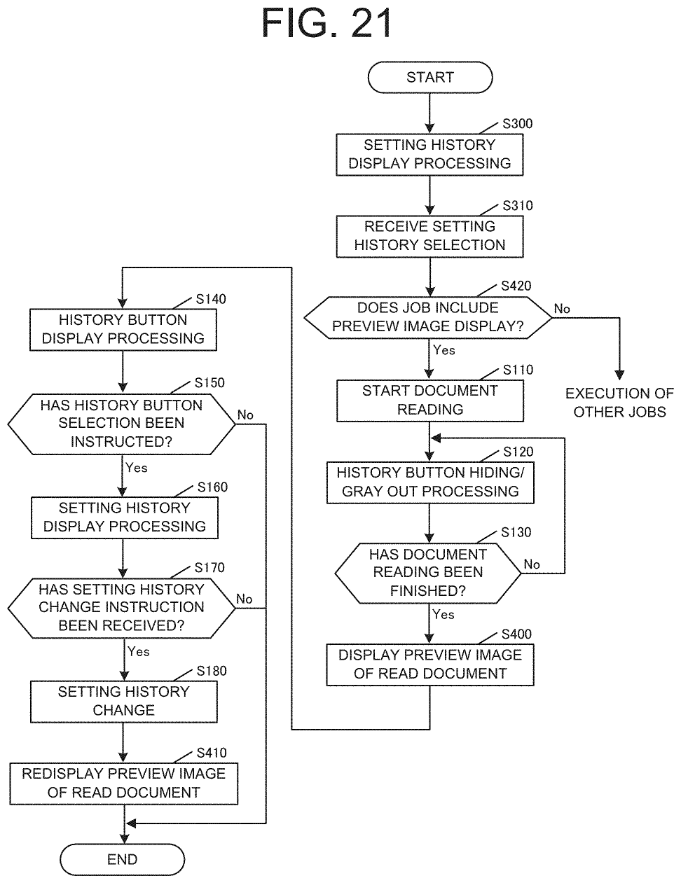

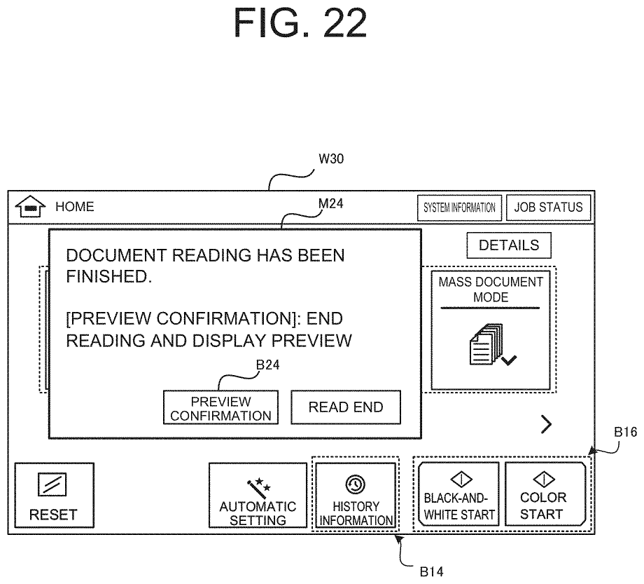

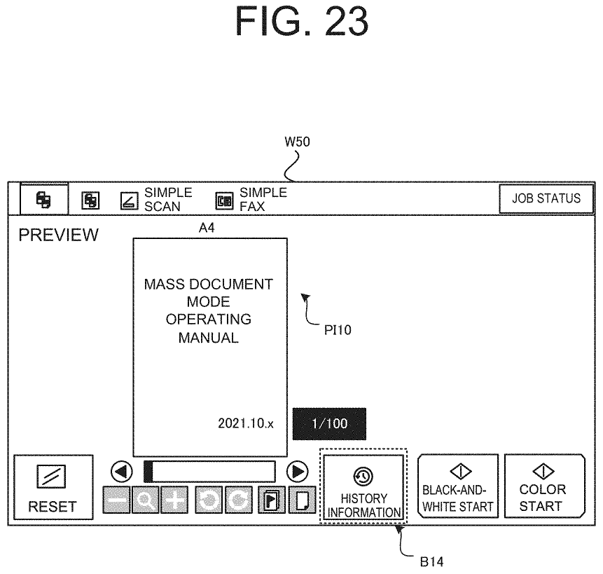

Next, a flow of processing according to the second embodiment will be described with reference to a flowchart of FIG. 17. As in the first embodiment, a controller 11 reads a job execution program 231, a setting history processing program 232, a display control program 233, and the like, thereby executing each processing step described referring to FIG. 17. The same step numbers are assigned to describe the same processing steps as those of the first embodiment described referring to FIG. 7.

When the controller 11 receives an instruction to display setting histories, the controller 11 displays a history information display screen on a display 13 (step S300).

Next, when the controller 11 receives an instruction of selecting a setting history via the history information display screen, the controller 11 determines whether a job corresponding to the setting history includes printing processing or transmission processing (step S310→step S320).

If the job is determined as including the printing processing or transmission processing, the controller 11 starts document reading (step S320; Yes→step S110). Meanwhile, if the job is determined as not including the printing processing or transmission processing, the controller 11 executes other jobs (step S320; No→“Execution of other jobs”).

When the document reading is started, the controller 11 performs display control to hide or gray out a history button (step S120). By restricting the display of the history button when an image reader 21 is reading a document, it is possible to prevent the user from operating (selecting) the history button by mistake.

Then, the controller 11 determines whether or not the document reading by the image reader 21 has been finished (step S130). Here, as the controller 11 receives a read end signal which is output from the image reader 21, the controller 11 can determine that the document reading has been finished. Also, the controller 11 may determine that the timing when a document detection signal from a document detection sensor (which is mechanical or optical) provided in the ADF is no longer detected, for example, corresponds to an end of the document reading.

If it is determined that the document reading by the image reader 21 has been finished, the controller 11 performs display processing for the history button (step S130; Yes→step S140). Meanwhile, if the controller 11 determines that the document reading by the image reader 21 has not been finished, the controller 11 continues the display control to hide or gray out the history button (step S130; No→step S120).

After performing the display processing for the history button, the controller 11 determines whether or not an instruction of selecting the history button by the user is received (step S150). If it is determined that an instruction of selecting the history button by the user is received, the controller 11 performs display processing of displaying the setting histories (step S150; Yes→step S160). If it is determined that no instruction of selecting the history button by the user is received, the controller 11 shifts the processing to step S210 (step S150; No→step S210).

Then, the controller 11 determines whether or not a setting history has been selected from among the displayed setting histories, and an instruction for change to the selected setting history is received (step S170).

If an instruction for setting history change is received, the controller 11 performs a change to the selected setting history (step S170; Yes→step S180). If it is determined that no instruction for setting history change is received, the controller 11 shifts the processing to step S210 (step S170; No→step S210).

When the controller 11 receives a document re-read instruction after performing the setting history change, the controller 11 controls the image reader 21 to (re-)read the document on the basis of the changed setting history (step S190). Then, the controller 11 determines whether or not re-reading of the document by the image reader 21 has been finished (step S200).

If it is determined that re-reading of the document has been finished, the controller 11 executes printing or transmission processing, on the basis of the document read result, and ends the processing (step S200; Yes→step S210).

Note that in step S170 and step S180 of FIG. 17, although the processing of performing a change to the setting history selected by the user has been described, it is of course possible to further change the setting values of the selected setting history. In this case, the controller 11 executes document read processing on the basis of the changed setting values.

FIG. 18 shows a configuration example of a setting screen W40 related to E-mail displayed by the controller 11, when history information RI10 on the history information display screen W10 exemplified in FIG. 4 is selected by the user.

The setting screen W40 includes a setting value display area R20, a control button display area R22, a start button B20, and a destination display area R24.

The setting value display area R20 receives selection/input of a setting value that can be set by the user via the setting screen W40. As the setting values (items) that can be set, FIG. 18 shows an example in which setting values (items), which are Color mode (Auto/Black-and-White Bitonal), Resolution (600 dpi×600 dpi), Format (PDF), Document (Auto), and Density (Auto), are displayed. The setting values (items) exemplified in the setting value display area R20 of FIG. 18 correspond to the setting history of history ID “0098” exemplified in FIG. 3.

The control button display area R22 includes, for example, a global address book search button, a transmission history button, a call by search number button, a direct transmission button, a program call button, a history information button B22, and the like. For example, the global address book search button receives input of an instruction to search for a transmission destination using a global address book as an address book. The transmission history button receives input of an instruction to search for a transmission destination from the transmission histories. The call by search number button receives input of an instruction to search for a transmission destination by a search number. The direct transmission button is to receive direct input of a transmission destination into the destination display area R24. The program call button is to receive an instruction to call a job program having stereotyped setting contents that are related to a transmission job. The history information button B22 is a button which receives an instruction to call the setting histories. When the history information button B22 is selected by the user, the controller 11 displays a history information display screen W10 exemplified in FIG. 4.

The start button B20 receives an instruction to execute an E-mail transmission job, When the start button B20 is selected, the controller 11 executes the E-mail transmission to the destination displayed in the destination display area R24.

The destination display area R24 is a display area for displaying a destination of the E-mail transmission. FIG. 18 shows an example in which the transmission destinations “AAA@sampleA.co.jp” and “BBB@sampleB.co.jp co.jp”, which are based on the setting history of history ID “0098” exemplified in FIG. 3, are displayed.

FIG. 19 is a diagram illustrating a configuration example of a message image M20 displayed in such a way as to be superimposed on the setting screen W40, when an E-mail job is to be executed via the setting screen W40. As the user confirms the message contents (for example, “Set document and press ‘Start’. Document will be read.”) displayed in the message image M20, and selects the start button B20, the E-mail job can be executed. When the start button B20 is selected, and reacting of the document is started, the controller 11 performs display control to hide or gray out the history information button B22.

FIG. 20 is a diagram illustrating a configuration example of a message image M22 displayed by the controller 11, when the document reading has been finished, and the react document (image) is to be sent by E-mail successively.

The message image M22 displays a message saying, for example, “Document reading has been finished. If you wish to proceed to transmission, press ‘Start’ button.”. By such a display, the user is informed of a start of the E-mail transmission.

At this time, the controller 11 performs display control. so that the history information button B22 is allowed to be selected. For example, if a read result of the previous document reading is not satisfactory to a user, he/she can select the history information button B22, reselect a setting history, and further make changes to the setting values, if necessary, before reading the document again.

As described above, according to the second embodiment, when a job is that which uses a setting history as history information, the display control of a history button as a reception image is performed, regardless of the mode in action. By this feature, it is possible to provide an image processing apparatus, for instance, which is excellent in operability also for users who may wish to make changes to the setting contents in the process of executing the job.

### 3. Third Embodiment

A third embodiment takes the form of displaying, when a job is that which uses a setting history as history information, and a mode is that which displays a preview image using a read result from an image reader, a history button as a reception image together with the display of the preview image, and displaying, if a setting history is called by way of selection of the history button, a preview image to which the setting values of the called setting history are applied.

### 3.1 Functional Configuration

Since the functional configuration of a multifunction peripheral according to the third embodiment can be made substantially the same as that of the multifunction peripheral 10 according to the first embodiment, the same functions are represented by the same reference numerals, and description thereof is omitted here.

### 3.2 Flow of Processing

Next, a flow of processing according to the third embodiment will be described with reference to a flowchart of FIG. 21. As in the first embodiment, a controller 11 reads a job execution program 231, a setting history processing program 232, a display control program 233, and the like, thereby executing each processing step described referring to FIG. 21. The same step numbers are assigned to describe the same processing steps as those of the first embodiment described referring to FIG. 7, and the second embodiment described referring to FIG. 17.

When the controller 11 receives an instruction to display setting histories, the controller 11 displays a history information display screen on a display 13 (step S300).

Next, when the controller 11 receives an instruction of selecting a setting history via the history information display screen, the controller 11 determines whether a job corresponding to the setting history includes preview image display (step S310→step S420).

If the job is determined as including preview image display, the controller 11 starts document reading (step S420; Yes→step S110). Meanwhile, if the job is determined as not including preview image display, the controller 11 executes other jobs (step S420; No→“Execution of other jobs”).

When the document reading is started, the controller 11 performs display control to hide or gray out a history button (step S120). By restricting the display of the history button when an image reader 21 is reading a document, it is possible to prevent the user from operating (selecting) the history button by mistake.

Then, the controller 11 determines whether or not the document reading by the image reader 21 has been finished (step S130). Here, as the controller 11 receives a read end signal which is output from the image reader 21, the controller 11 can determine that the document reading has been finished. Also, the controller 11 may determine that the timing when a document detection signal from a document detection sensor (which is mechanical or optical) provided in the ADF is no longer detected, for example, corresponds to an end of the document reading.

If it is determined that the document reading by the image reader 21 has been finished, the controller 11 displays a preview of a document read result (step S130; Yes→step S400). Meanwhile, if the controller 11 determines that the document reading by the image reader 21 has not been finished, the controller 11 continues the display control to hide or gray out the history button (step S130; No→step S120).

Then, the controller 11 performs display processing for the history button (step S140).

After performing the display processing for the history button, the controller 11 determines whether or not an instruction of selecting the history button by the user is received (step S150). If it is determined that an instruction of selecting the history button by the user is received, the controller 11 performs display processing of displaying the setting histories (step S150; Yes→step S160). If it is determined that no instruction of selecting the history button by the user is received, the controller 11 ends the processing (step S150; No→End).

Then, the controller 11 determines whether or not a setting history has been selected from among the displayed setting histories, and an instruction for change to the selected setting history is received (step S170).

If an instruction for setting history change is received, the controller 11 performs a change to the selected setting history (step S170; Yes→step S180). If it is determined that no instruction for setting history change is received, the controller 11 ends the processing (step S170: No→End).

After performing the setting history change, the controller 11 redisplays a preview image in which the setting values of the setting history that has been changed in step S180 are applied to the preview image displayed in step S400, and ends the processing (step S410).

Note that in step S170 and step S180 of FIG. 21, although the processing of performing a change to the setting history selected by the user has been described, it is of course possible to further change the setting values of the selected setting history. In this case, the controller 11 executes document read processing on the basis of the changed setting values.

### 3.3 Operation Examples

Next, an operation example according to the third embodiment will be described. FIG. 22 is a diagram illustrating a configuration example of a message image M24 to be displayed after the document reading of step S130 in FIG. 21.

After the document reading, the controller 11 displays the message image M24 saying, for example, “Document reading has been finished. [Preview Confirmation]: End reading and display preview”, together with the display of a history information button B14. The message image M24 includes a preview confirmation button B24, and after the user has confirmed the message contents, he/she can select the preview confirmation button B24 to confirm the document read result by a preview image. The user can confirm the document read result based on the setting history selected in step S310 of FIG. 21 by a preview image.

Meanwhile, if the history information button B14 is selected, and the processing related to step S150 to step S180 of FIG. 21 is executed, the controller 11 displays a preview image in which the setting values of the changed setting history are applied. The user can thereby execute a conclusive output, which is printing processing or transmission processing, etc., after confirming the preview image based on the changed setting history.

FIG. 23 is a diagram illustrating a configuration example of a preview screen W50 displayed by the controller 11 in step S400 of FIG. 21. The preview screen W50 includes, in addition to a display area that displays a preview image PI10, the history information button B14. If the user checks the preview image PI10, and is not satisfied with a document read result, he/she can select the history information button B14, and check a preview image that has been redisplayed on the basis of a different setting history.

As described above, according to the third embodiment, when a history button as a reception image is displayed together with display of a preview image, and a setting history is called via selection of the history button, it is possible to confirm a preview image to which the setting values of the called setting history are applied. The user can thereby execute a conclusive output, which is printing processing or transmission processing, etc., after confirming the preview image based on the changed setting history.

### 4. Other Embodiments

In the first embodiment, as one form of the mode, the mass document mode and the trial printing mode have been described. However, apart from the above modes, the present disclosure is applicable to, for example, each of the following modes:

(1) Page aggregation mode;
(2) Card scan mode;
(3) Blank page skip mode;
(4.) Mixed document mode;
(5) Connected copy mode;
(6) Multi-crop scan/Photo crop mode; and
(7) Encryption mode.

Here, mode (1), i.e., the page aggregation mode, refers to a mode of aggregating the substance of a plurality of documents into a single document. Mode (2), i.e., the card scan mode, refers to a mode of digitizing card information indicated on a card medium such as a membership card, an employee ID card, and a credit card. Mode (3), i.e., the blank page skip mode, refers to a mode of automatically avoiding, when documents related to document reading include a blank page, reading of the blank page. Mode (4), i.e., the mixed document mode, refers to a mode of automatically changing, when documents related to document reading include a document of a different size, a document read size according to the size. Mode (5), i.e., the connected copy mode, refers to a mode of connecting two multifunction peripherals of the same model to each other, for example, transferring the contents of the setting made on one of the multifunction peripherals to the other multifunction peripheral, and performing copying by the two multifunction peripherals. Mode (6), i.e., the multi-crop scan/photo crop mode, refers to a mode of setting a plurality of documents (of relatively small size) related to document reading on a document table, and automatically extracting and digitizing the respective documents. Mode (7), i.e., the encryption mode, refers to a mode of encrypting documents related to document reading.

Each of the modes exemplified above is a mode that, belongs to a scheme or a method for executing, changing, or canceling a conclusive output on the basis of a document read result. Therefore, in mode (1), i.e., the page aggregation mode, for example, after a plurality of documents have been read, a history button is selectively displayed together with a message image asking about a result of the page aggregation to the user. By such display, the same advantages as those of the present disclosure can be obtained.

The present disclosure is not limited to the above-described embodiments, and various changes can be made. That is, embodiments obtained by combining techniques modified as appropriate within a range that, does not depart from the gist of the present disclosure are also included in the technical scope of the present disclosure.

Further, although the above-described embodiments include some parts described separately for convenience of explanation, it is needless to say that the embodiments may be combined within a technically possible range and implemented.

In addition, the program to be operated on each of the devices in the embodiments is a program that controls the CPU or the like (i.e., a program which makes a computer function) so as to implement the functions of the above-described embodiments. The information handled by the devices is temporarily accumulated in a temporary storage device (for example, a RAM) during processing of the information, and then, is stored in various storage devices such as a read-only memory (ROM) and an HDD, and is read, modified, and written by the CPU as necessary.

A recording medium used for storing the program may be any one of a semiconductor medium (for example, a ROM, a non-volatile memory card, or the like), an optical recording medium or a magnetooptical recording medium (for example a digital versatile disc (DVD), a magnetooptical disc (MO), a mini disc (MD), a compact disc (CD), a Blu-ray (registered trademark) disc (BD), or the like), and a magnetic recording medium (for example, a magnetic tape, a flexible disk, or the like). Moreover, not only are the functions of the embodiments described above implemented by execution of a loaded program, but the functions of the present disclosure may also he implemented by processing performed in cooperation with an operating system, other application programs, or the like, on the basis of an instruction of the program.

Furthermore, when the program is to be distributed to the market, the program may be stored in a portable recording medium for distribution or transferred to a server computer connected via a network such as the Internet. In this case, a storage device of the server computer is, as a matter of course, included in the present disclosure.

What is claimed is:

1. An image processing apparatus comprising:
a job executor which executes a job according to a mode;
a storage which stores, as history information, a setting value of the job;
a display which allows a reception image, which receives an instruction to call the history information that has been stored, to be displayed; and
a controller which performs, during execution of the job, display control of the reception image according to the mode.

2. The image processing apparatus according to claim 1, further comprising a reader which reads a document, wherein
the controller restricts display of the reception image when the document is being read by the reader.

3. The image processing apparatus according to claim 1, wherein:
the mode is a first mode of reading documents through multiple divided reads from a reader; and
the controller performs the display control of the reception image, at time during execution of the job according to the first mode.

4. The image processing apparatus according to claim 3, wherein the controller displays the reception image when the reader is not performing an operation of reading the document, at time during execution of the job according to the first mode.

5. The image processing apparatus according to claim 1, wherein:
the mode is a second mode of requiring judgment of a user on a read result of a document from a reader; and
the controller performs the display control of the reception image, at time during execution of the job according to the second mode.

6. The image processing apparatus according to claim 5, wherein the controller displays the reception image when the user is to be asked for the judgement, at time during execution of the job according to the second mode.

7. The image processing apparatus according to claim 1, wherein the controller performs the display control of the reception image regardless of the mode, when the job is a job that uses the history information.

8. The image processing apparatus according to claim 1, wherein the controller:
displays, when the job is a job that uses the history information, and the mode is a mode that displays a preview image using a read result of a document from a reader, the reception image together with display of the preview image; and
displays, when the history information is called via the reception image, the preview image to which the setting value of the called history information is applied.

9. The image processing apparatus according to claim 2, wherein the controller restricts the display by hiding or graying out the reception image.

10. A display control method comprising:
executing a job according to a mode;
storing, as history information, a setting value of the job;
displaying, on a display device, a reception image which receives an instruction to call the history information that has been stored; and
performing, during execution of the job, display control of the reception image according to the mode.
